(19) United States
(12) Patent Application Publication
(10) Pub. No.: US 2006/0148633 A1
(43) Pub. Date: Jul. 6, 2006

(54) Bioactive ceramic composite materials and methods for the production thereof

(75) Inventors: Martina Kuhn, Schwanewede (DE); Dietmar Koch, Bremen (DE); Georg Grathwohl, Bremen (DE); Ulrich Soltmann, Dresden (DE)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: Universitat Bremen, Bremen (DE)

(21) Appl. No.: 10/540,936

(22) PCT Filed: Jan. 14, 2004
(86) PCT No.: PCT/EP04/00209

§ 371 Date: Dec. 14, 2005

(30) Foreign Application Priority Data
Jan. 17, 2003 (DE) 103 1 669.4

(51) Int. Cl. C04B 35/00

(52) U.S. Cl. 501/1

(57) ABSTRACT

A ceramic composite material containing a ceramic substrate material, in which the at least one biological material, and at least one nanoparticulate reinforcing material are homogenously embedded, and a method for the production of the composite material are described.

The invention relates to ceramic composite materials, in particular to bioactive ceramic composite materials, as well as to methods for the production and applications of the composite materials.

It is known that currently great efforts are being made to immobilize biomolecules and living cells in inorganic matrices, because as compared to the currently used polymer templates, the following benefits are expected in particular:
high mechanical, thermal, and photochemical stability,
high transparency,
biological inertness (i.e. no nutrient source for microorganisms), and
controllable porosity and a variable degree of immobilization.

Such biocomposite materials offer numerous new potentially beneficial application possibilities, such as for the production of biocompatible surfaces in medical engineering, for biocatalysis, biogenesis, and for novel active agent release systems.

In addition to the possibility of adsorptively fixing biomolecules or bacterial cells to inorganic carriers, such as silica gel, bentonite, and others, to the surface, as described in e.g., IN 171047, there exists the possibility of directly embedding biomolecules in an inorganic matrix by means of utilizing sol-gel-technology (compare C. J. Brinker and G. Scherer in “Sol-Gel Science: The Physics and Chemistry of Sol-Gel-Processing,” Academic Press Inc., Boston 1990).

In this manner, for example, the embedding of enzymes or proteins in inorganic matrices is possible (see for example U.S. Pat. No. 5,200,334, or U.S. Pat. No. 5,300,564). In a principally similar manner, after the immobilization of living yeast cells in SiO₂-sol-gel matrices (G. Carturan et al., Mol. Catal. 57 (1989) L13) cell tissue was encapsulated into organosilicons (U.S. Pat. No. 5,693,513), plant cells were encapsulated into porous SiO₂-gels (WO 96/36703), animal cells were encapsulated into a gel, produced from an organosilicon (U.S. Pat. No. 5,739,020), or an SiO₂-layer created from a gas phase (WO 97/45537), respectively. Furthermore, for the encapsulating of microorganisms the combination of SiO₂-gels with water soluble polymers, such as polyvinyl alcohol, gelatin (U.S. Pat. No. 4,148,689), or alginates (U.S. Pat. No. 4,797, 358, WO 96/35780) has been described.

One alternative to the sol-gel systems should be the homogenous embedding of biomolecules into ceramic materials for practical purposes, because compared to sol-gel matrices, these are less expensive, more stable and formable, and furthermore, an established production technology is available. However, one obstacle is currently still the necessity of reinforcing classical ceramic moldings by means of a sintering process at high temperatures, such as above 600° C. However, since any organic matter will be destroyed at these temperatures, it has not been possible to embed biomolecules or living cells into conventional ceramic masses.

DE 100 65 138 describes the production of porous ceramic moldings in deviation of the classical methods used at low temperatures. In this method a special composition of a ceramic suspension is used, which is subjected to a freeze-drying process that is controlled in a specific manner. In the method known from DE 100 65 138, however, an embedding of biomaterials could not be considered, since an additional treatment with acids or bases was required after the drying process for the reinforcing of the ceramic moldings, which was destructive to biomaterials. The purpose of the additional treatment is a lixiviation resulting in reinforcement of the composite.

Therefore, biomolecules or microorganisms have currently been added to ceramic masses as auxiliary agents (pore-forming substances) only, which result in a controlled porosity of the ceramics during the sintering process, such as for artificial bone materials (GB 2 365 423) or for other functional ceramics (U.S. Pat. No. 5,683,664, EP 631 998).

The immobilization of living microorganisms to ceramics was currently possible only by means of subsequent impregnation of porous ceramic surfaces with aqueous dispersions of microorganisms (WO 98/13307). This method, however, has a series of disadvantages: the degree of immobilization is low, the reproducibility is poor, and the ceramics suitable for this require mean pore sizes, which are greater than the sometimes substantial size of the microorganisms.

The object of the invention is to provide improved ceramic composite materials containing at least one biomaterial, whereas the composite materials should avoid the disadvantages of traditional composite materials. The object of the invention in particular is to provide composite materials with an improved degree of immobilization for the at least one biomaterial, and an increased viability, and/or effectiveness of the biomaterial. Composite materials according to the invention should further be producible with an expanded range of medium pore sizes, and usable for new applications. A further object of the invention is to provide improved methods for the production of such composite materials, which are particularly characterized by the gentle processing of the biomaterial.

These objects are achieved by means of the composite materials and methods having the features of claims 1 or 15. Advantageous embodiments and applications of the invention are evident from the dependent claims.

A first basic aspect of the invention is to develop a ceramic composite material formed on the basis of a ceramic substrate material in such a manner that at least one biological material and at least one reinforcing material are homogenously embedded into the substrate material, whereas the reinforcing material comprises inorganic nanoparticles formed from a nanoparticulate sol, which are connected to one another. A nanoparticulate, gel-forming and cross-linking reinforcing material is used. The homogenous embedding of the biomaterial into the composite material results in a high degree of immobilization, and therefore a high stability and long lasting effectiveness of the composite material. The reinforcing material contained within the composite material enables the use of a procedure for the reinforcement of ceramic at low temperatures, which is gentle for the biomaterial.

The bioactive ceramic composite material according to the invention comprising a ceramic substrate, and, for example living cells homogenously distributed therein, can be produced at temperatures that are so low that no denaturing of the cell material occurs during the reinforcing process. The invention ensures such a high viability of the embedded cells that the use of the biocomposite material, for example as a biocatalyst or biofilter for the treatment of polluted water, is possible.

With regard to the process, the invention is based in particular on a modification of the method known from DE 100 65 138 in that by means of the use of the nanoparticulate reinforcing material according to the invention the traditional use of acids for the purpose of lixiviation leading to the composite reinforcement is dispensable. It was surprisingly shown that the method according to the invention enables the reinforcement of the composite at room temperature, or at lower temperatures.

The ceramic composites according to the invention are preferably produced by means of reinforcing of generally known ceramic slurries consisting of aqueous dispersions of aluminum oxide or alumosilicate powders or fibers. The use of fibrous material is particularly advantageous, because it allows the production of particularly mechanically stable moldings at room temperature. With the use of aqueous dispersions, the admixture of aqueous cell dispersions is also possible without any problems.

An essential characteristic of the invention is reinforcing the slurry by means of the admixture of an inorganic nanosol capable of gelling. For this purpose, preferably nanosols with a mean particle diameter of below 200 nm are used. According to preferred embodiments of the invention the reinforcing nanosols consist of nanoparticulate oxides of elements of the II to V main or subgroup of the periodic table, or the mixtures thereof in water, or an aqueous-organic solvent. For example, nanosols of SiO₂, Al₂O₃, ZrO₂, TiO₂, B₂O₃, ZnO, CaO, P₂O₅, or the mixtures thereof may be used, which are obtained, for example, by means of acidic or alkaline hydrolysis of the respective metal alkoxides.

For modification of the nanosol properties, the hydrolysis process of the metal alkoxides may be performed in the presence of admixed trialkoxy silanes R—Si(OR′)₃, and/or dialkoxy silanes R₂—Si(OR′)₂, which leads to the forming of modified metal oxide sols, which contain 0 to 2 parts by weight of R—SiO_{3/2}, and/or R₂—SiO based on one part by weight of metal oxide. R stands for an organic alkyl or aryl residue, which may contain amino, hydroxyl, epoxy, or alkoxyl groups, or is substituted by halogens. R′ stands for an alkyl residue, preferably with 1 to 16 carbon atoms. With this modification, for example, the mechanical and surface properties of the composites may be specifically adjusted to the respectively desired application. The proportion of the reinforcing material within the composite can be up to 70 percent by weight, depending on the desired degree of reinforcement.

The method for the production of bioactive ceramic composite materials according to the invention allows the effective immobilization of a broad spectrum of various biomaterials, specifically the use of living organisms, such as bacteria, fungi, algae, and protozoans. Correspondingly, multi-cellular animal and vegetable cell aggregates may also be immobilized. The proportion of living cells can be preferably up to 30 wt.-%, based on the dried biocomposite.

As an alternative, the method is suitable for the immobilization of dead cells, cell components, enzymes, and other proteins, biopolymers, and other bioactive molecular agents. In order to increase the utility value properties of the bioactive ceramic composite materials, the admixture of special additives may be beneficial. In order to increase the biological activity, glycerol or other polyols, and/or nutrients may be added.

According to a further advantageous embodiment of the invention, the dispersibility of the slurry components can by improved by adding water soluble polymers, such as polyvinyl alcohol or polyacrylic acid, and the mechanical stability of the bioactive ceramic composite materials may be increased by polar interactions of the inorganic oxide matrix. The proportion of the additives can preferably be up to 30 wt.-% based on the dry biocomposite.

The method for the production of a bioactive ceramic composite material is characterized in particular by the following steps:
(1) mixing a slurry of an aqueous dispersion of aluminum oxide or aluminosilicate powders or fibers and the dispersed biomaterial, in particular the bioactive cell material,
(2) adding the nanoparticulate reinforcing material, and optionally other additives for improving the biological activity and increasing the mechanical stability, and
(3) reinforcing the material; optionally in molds, by means of

(a) A Freeze-Casting Process (Compare to Example 1)

Freeze-casting (or: freeze-gelling) is a shaping method, in which the mixture of a ceramic powder and the reinforcing nanosol is frozen in a freezer or a liquid-nitrogen bath, whereas the sol is irreversibly converted into the gel phase, thereby enveloping the ceramic grains and cross-linking them with one another. The crystallized water is removed either by means of thawing and evaporation, or (in case of common freeze-drying) by means of sublimation. The freeze-casting process is characterized in an advantageous manner by a homogenous structure and a good dimensional stability of the moldings, as well as by a low drying shrinkage after freezing, which requires little post-processing.

(b) Neutralization at Room Temperature (Compare to Example 2)

Particularly in the case of slurry material based on fibrous oxides (such as sintered mullite), reinforcing will be achieved at room temperature by means of neutralization, since the nanosols will gel spontaneously at the neutral point, and cross-linking and reinforcement processes similar to that of freeze-casting will take place. According to a particular benefit of the invention, the shaping according to (3a) may be performed at temperatures below the freezing point of water, at which the viability of biomaterials is preserved. It may be particularly advantageous if the freeze-casting is performed at temperatures of up to −80° C. and the possible freeze-drying at temperatures of up to −40° C.

Subsequent to the freezing according to (3a) the so-called green body is removed from the metal mold in its frozen state and then freeze-dried. According to (3b) the green body is air-dried at room temperature, or dried in vacuum after its neutralization and solidification.

Due to the production of the bioactive ceramic composite material at low temperatures and low residual moisture, a high viability of the immobilized cells and bioactivity is ensured. That is why these types of composite materials can be used in the shape of a molding or of a membrane as a biocatalyst or a biofilter for the treatment of polluted wastewater. Due to their good mechanical stability, crushed moldings are advantageously suitable as column filling material in bioreactors.

Successful trials were performed for the use of composites according to the invention with
(i) immobilized yeast cells Saccaromyces cerevisiae as a fermentation catalyst
(ii) immobilized bacteria Bacillus sphaericus as a biofilter for the removal of heavy metal ions from uranium wastewater
(iii) immobilized bacteria Rhodococcus spec. as a biocatalyst for the degradation of phenol and glycols in saline industrial wastewater.

Furthermore, the bioactive ceramic composite materials according to the invention offer new possibilities for the production of porous ceramics with a defined uniform pore size, in that by means of the thermal decomposition of the biological components at temperatures of at least 500° C. ceramic materials are created with a pore structure that corresponds to the shape and quantity of the immobilized biocomponents (compare to example 3). Spherical yeast spores are of particular interest due to their easy accessibility and their almost monodisperse size distribution, which will leave behind form-persistent pores during the volatilization in the course of the sintering process. It was observed that various biological components act as an organic binder, and form firm shrinkage-free green bodies at temperatures of at least 70° C. In this manner, the proportion of nanoparticulate reinforcing means may be drastically reduced for the production of bioactive ceramic composite materials.

Thus, the benefits of the bioactive ceramic composite materials according to the invention can be summarized as opposed to prior art as follows:
for the first time, living cells can be immobilized at a high biological activity, while retaining their viability in a ceramic molding,
the bioactive ceramic composite materials can be formed into any desired shape, depending on the requirements of the specific application, and show a high mechanical stability,
the porosity of the composites, and therefore their biological activity and reactivity can be controlled to a broad extent by means of the composition type and production technology,
the method can be applied universally,
according to the invention different microorganisms and cell systems can be converted into a composite,
numerous applications as a biocatalyst or biofilter are possible, and
the thermal removal of the biocomponent offers new possibilities for the production of porous ceramics.

### EMBODIMENTS

### Example 1

### Immobilization of Bacillus spaericus and Saccharomyces cerevisiae by Means of Freeze-Casting

(a) Production of the Composite Material

Bacillus sphaericus cells, respective spores (obtained from the cells by means of reduced provision of nutrition and the admixture of manganese salts), as well as ordinary baker's yeast cells (Saccaromyces cerevisiae) were used as the cell material.

The slurry was of the following composition:
+54 wt.-% mullite (Mullit73, Osthoff-Petrasch, Hamburg), and 16 wt.-% Al₂O₃ (mean particle diameter 700 nm) as the ceramic matrix
+27 wt.-% Nyacol 1440 (Akzo Nobel Chemicals Wurzen) as the nanoparticulate reinforcing material, silica sol with a 40% solids content and a mean particle diameter of 14 nm, 3% glycerol as an additive.
+4 ml of the slurry solution was mixed with 1 ml cell culture each with defined cell numbers, and dropped onto a −40° C. metal plate, which results in the forming of pellets (with a diameter of 3 to 6 mm), or discs (3 cm diameter, 1 cm height), which subsequently are freeze-dried.

b) Testing of the Composite Material

TABLE 1
number of living Bacillus sphaericus cells and
spores (CFU) after storage at 4° C.
(as determined by a cultivation test)

| | Living cells | Living spores |
|---|---|---|
| Storage time/days | CFU/g of composite | CFU/g of composite |
| 6 | 1.2 × 10⁶ | 6.4 × 10⁶ |
| 124 | 9.0 × 10 | 5.7 × 10⁶ |

TABLE 2
number of living cells
(as determined by a cultivation test)

| | | B. sphaericus | Saccaromyces cerevisiae |
|---|---|---|---|
| non- | Control | 1.1 × 10⁹/15 μl | 3.2 × 10⁶/1.5 mg |
| immobilized | Freeze- | 2.1 × 10⁵/15 μl | — |
| cells | dried | | |

| | | |
|---|---|---|
| freeze-casting | 7 × 10⁴15 μl | 4 × 10³/1.5 mg resp. 100 mg |
| composite | resp. 10 mg | composite |
| | composite | |

TABLE 3
biological activity of 100 mg of biocomposite
compared to the respective amount of non-immobilized cells
(using microbiologic standard tests)

| | Bacillus sphaericus | | Saccaromyces cerevisiae | |
|---|---|---|---|---|
| | non- | | non- | |
| Substrate | immobilized | biocomposite | immobilized | biocomposite |
| FDA¹⁾ | 26 nMol/h | 7 nMol/h | — | — |
| resazurin²⁾ | 89 nMol/h | 40 nMol/h | — | — |
| glucose³⁾ | — | — | 16 μMol/h | 2.2 μMol/h |

¹⁾Enzymes (esterases) formed by the cells hydrolyze fluorescein diacetate (FDA)
²⁾Enzymes (dehydrogenases) formed by the cells reduce resazurin (blue) to resorufin (pink)
³⁾biocatalytic conversion of glucose

### Example 2

### Immobilization of Saccharomyces cerevisiae at Room Temperature and with Air-Drying

(a) Production of the Composite Material

The slurry was of the following composition:
20.5 wt.-% Al₂O₃ fibers
20.5 wt.-% Al₂O₃ powder (mean particle diameter 700 nm)
56.5 wt.-% Nyacol 1440 (Akzo Nobel Chemicals Wurzen)
2.5 wt.-% dry yeast

The Nyacol is neutralized with HCl. The dry yeast is suspended in approximately ⅓ of the Nyacol. The Al₂O₃ fibers and powders are mixed with the remaining Nyacol, and the Nyacol/yeast mixture is then added. This results in a paste-like mass, in which the yeast cells are homogenously distributed. The slurry is spread to a layer of about 0.5 cm thickness, compacted at a forming pressure of 1.5 kN, and air-dried. The pourability may be improved by adding water, or possibly by increasing the proportion of Nyacol. The plates were then sawed into cubes, and tested as to their biological effectiveness.

(b) Testing of the Composite Material

TABLE 4
number of living Saccaromyces cerevisiae cells and
their biological activity in 100 mg biocomposite compared
to the respective amount of non-immobilized cells
(using microbiologic standard tests)

| | Living cells | Biological activity |
|---|---|---|
| biocomposite | 7 × 10⁵ CFU/100 mg | 7.3 μMol/h × 100 mg |
| | composite | composite |
| non-immobil- | 1.6 × 10⁷ CFU/2.5 mg free | 60.3 μMol/h × 2.5 mg free |
| ized cells | cells | cells |

### Example 3

### Thermal Conversion of a Bioactive Ceramic Composite Material into Porous Ceramics

Aqueous slurry made up of 40 g Al₂O₃ powder, 45 g Al₂O₃ fibers and 5 g Nyacol 1440 is dried as a pre-mixture and placed into a suspension containing 10 g Bacillus spaericus. The suspension is poured into a mold and dried at 70° C. After drying, a firm green body is present, which maintains its shape. The green body can be, for example, sintered at up to 1400° C. so that it results in highly porous, shrinkage-free ceramics.

1. A ceramic composite material comprising:
a ceramic substrate material;
at least one biological material; and
at least one nanoparticulate reinforcing material,
wherein the at least one biological material, and the at least one nanoparticulate reinforcing material are homogenously embedded in the ceramic substrate material, and the at least one nanoparticulate reinforcing material comprises inorganic nanoparticles that are linked to one another, and are formed from a nanoparticulate sol, and cross-links the substrate material.

2. The composite material according to claim 1, wherein the at least one nanoparticulate reinforcing material comprises nanoparticulate oxides of elements of the II to V main or subgroup of the periodic table, or mixtures thereof.

3. The composite material according to claim 2, wherein the at least one nanoparticulate reinforcing material comprises nanoparticulate hydrolysis products of trialkoxy silanes, or mixtures thereof.

4. The composite material according to claim 1, wherein a proportion of the at least one nanoparticulate reinforcing material is up to 70 percent by weight.

5. The composite material according to claim 1, wherein the at least one nanoparticulate reinforcing material comprises nanoparticles with a mean particle diameter smaller than 200 nm.

6. The composite material according to claim 1, wherein the at least one biological material comprises biological cells, cell groups, cell components, or biologically effective macromolecules.

7. The composite material according to claim 6, wherein the at least one biological material comprises living or viable organisms.

8. The composite material according to claim 7, wherein the at least one biological material comprises bacteria, fungi, spores of bacteria or fungi, protozoans, algae, animal cells, vegetable cells, animal cell groups, or vegetable cell groups.

9. The composite material according to claim 7, wherein a proportion of the living or viable organisms is 0.1 to 30 wt.-% based on a dry weight of the composite material.

10. The composite material according to claim 1, wherein the ceramic substrate material comprises aluminum oxide or alumosilicate.

11. The composite material according to claim 1, wherein at least one additive for increasing a biological activity, and/or at least one water soluble polymer is/are embedded in the ceramic substrate material.

12. The composite material according to claim 11, wherein the at least one additive for increasing the biological activity comprises polyols, glycerol, and/or nutrients.

13. The composite material according to claim 11, wherein the at least one water soluble polymer comprises polyvinyl alcohol or polyacrylic acid.

14. The composite material according to claim 11, wherein a proportion of the at least one additive embedded in the ceramic substrate material is up to 30 wt.-% based on a dry weight of the composite material.

15. A method for the production of a ceramic composite material according to claim 1, comprising the following steps:
producing a slurry comprising an aqueous dispersion of the ceramic substrate material and a dispersion of the at least one biological material,
adding to the slurry an inorganic nanosol capable of gelling,
reinforcing the ceramic composite material by neutralization of the slurry with the at least one nanoparticulate reinforcing material at room temperature, or by a freezing process so that the composite material is formed, and
final drying of the ceramic composite material.

16. The method according to claim 15, wherein aluminum oxide or alumosilicate powder or fibers are added to the slurry as the ceramic substrate material.

17. The method according to claim 15, wherein additional additives are added to the slurry for improving biological activity and increasing mechanical stability.

18. The method according to claim 15, wherein the reinforcing is carried out in a mold.

19. The method according to claim 15, wherein the freezing process comprises a freeze-treatment of the ceramic composite material at a temperature of up to −80° C.

20. The method according to claim 15, wherein the drying of the ceramic composite material comprises freeze-drying at a temperature below a freezing point of water at up to −10° C.

21. A method for the treatment of fluids, said method comprising:
providing a biocatalyst or biofilter comprising a ceramic composite material according to claim 1; and
contacting the biocatalyst or biofilter with the fluids to treat the fluids.

22. A method for producing ceramic materials, said method comprising providing a ceramic composite material according to claim 1.

23. The composite material according to claim 1, wherein the composite material is a molding.

24. A molding produced from the composite material of claim 1.

25. The method according to claim 15, wherein the reinforcing comprises a freezing process.

26. The method according to claim 15, wherein the reinforcing comprises neutralization of the slurry with the inorganic nanosol at room temperature.
